(19) United States
(12) Patent Application Publication
(10) Pub. No.: US 2013/0107707 A1
(43) Pub. Date: May 2, 2013

(54) EMULATING NETWORK TRAFFIC SHAPING

(71) Applicants: Sivasundar Ramamurthy, San Jose, CA (US); David S. Curry, San Jose, CA (US); Steven B. Licking, San Jose, CA (US); Prabahar Radhakrishnan, San Jose, CA (US); Paul M. Hallinan, San Carlos, CA (US); Michael James Wurst, Santa Rosa, CA (US); Murray C. Bowles, San Jose, CA (US)

(72) Inventors: Sivasundar Ramamurthy, San Jose, CA (US); David S. Curry, San Jose, CA (US); Steven B. Licking, San Jose, CA (US); Prabahar Radhakrishnan, San Jose, CA (US); Paul M. Hallinan, San Carlos, CA (US); Michael James Wurst, Santa Rosa, CA (US); Murray C. Bowles, San Jose, CA (US)

(73) Assignee: TELLABS OPERATIONS, INC., Naperville, IL (US)

(21) Appl. No.: 13/286,852

(22) Filed: Nov. 1, 2011

(51) Int. Cl. H04L 12/26

(52) U.S. Cl. 370/230.1

(57) ABSTRACT

A system, method, and computer-readable medium for emulating traffic shaping. The method includes pre-coloring a packet to provide a pre-colored packet. The pre-colored packet is policed to provide a policed packet. In an example embodiment, the pre-coloring of the packet is performed based on (i) a meterstate and (ii) a true color of the packet. In a further example embodiment, a connection identifier associated with the packet is retrieved from a header of the packet and the connection identifier is correlated with the meterstate. In another example embodiment, the policed packet is marked with a true color of the packet, to provide a marked packet and the marked packet is discarded or forwarded, based on the policed packet.

### BACKGROUND OF THE INVENTION

1. Field of the Invention

Example aspects described herein relate to traffic management, quality of service (QoS), and, in particular, to systems, methods, and computer program products for emulating traffic shaping on an Ethernet line card (ELC).

2. Description of the Related Art

Computer networks often include components, such as Ethernet line cards (ELCs), that employ various methods in order to ensure sufficient network QoS. Examples of such methods include traffic policing and traffic shaping. Traffic policing, in general, is the process of monitoring network traffic for compliance with a traffic contract and taking steps to enforce that contract. Traffic that exceeds a traffic contract may be discarded immediately, marked as non-compliant, or left as-is, depending on a predetermined administrative policy and/or the characteristics of the excess traffic. Traffic shaping, in general, is the controlling of network traffic in order to optimize or guarantee performance, improve latency, and/or increase usable bandwidth for certain kinds of packets by delaying other kinds of packets that meet certain criteria.

A service class generally refers to a classification of network traffic that corresponds to a particular level of service. Circuitry provided on some ELCs employ service classes to satisfy a service-level agreement (SLA) that defines a level of service agreed upon by a service provider and a customer. Supporting a wide range of service classes on ELC circuitry requires the capability to police and shape traffic from customer premises equipment (CPE). In some cases, however, an ELC does not provide queues and/or shaping modules that are sufficient to support per-service queuing and/or shaping of ingress traffic, particularly in view of the scalability requirements commonly imposed on network components. Consequently, such an ELC, if limited to using the queues and/or shaping modules provided by the ELC to perform ingress traffic shaping, would be unable to support service classes that require such traffic shaping.

### SUMMARY

Existing limitations associated with the foregoing, and other limitations can be overcome by systems, methods, and/or computer program products described herein.

In one example embodiment herein, a method is provided for emulating traffic shaping. The method includes pre-coloring a packet to provide a pre-colored packet, and policing the pre-colored packet to provide a policed packet.

In one example embodiment, the pre-coloring of the packet is performed based on (i) a meterstate and (ii) a true color of the packet.

In a further example embodiment, the method further includes retrieving from a header of the packet a connection identifier associated with the packet, and correlating the connection identifier with a meterstate.

In yet another example embodiment, the method further includes marking the policed packet with a true color of the packet, to provide a marked packet.

In a further example embodiment, the method further includes discarding or forwarding the marked packet, based on the policed packet.

In a further example embodiment, the method further includes incrementing a value of at least one of (i) a pass packet counter upon forwarding of the marked packet and (ii) a congestion discard counter upon discarding of the marked packet.

The meterstate can include, in one example, at least one of a translate field, a shaper enable field, at least one translation field, a color aware field, a skip policing field, and at least one pre-color field.

In one example, the at least one translation field includes at least one of a green translation field, a yellow translation field, and a red translation field, and the at least one pre-color field includes at least one of a green pre-color field, a yellow pre-color field, and a red pre-color field.

In one example embodiment, the pre-coloring includes selecting a value of the at least one pre-color field, based on a true color of the packet, and marking the packet with the value selected in the selecting.

The pre-coloring also can include marking the packet with a value corresponding to a color of green.

### BRIEF DESCRIPTION OF THE DRAWINGS

The teachings claimed and/or described herein are further described in terms of exemplary embodiments. These exemplary embodiments are described in detail with reference to the drawings. These embodiments are non-limiting exemplary embodiments, wherein:

FIG. 1 illustrates an exemplary communication network, such as, for example, a multiprotocol label switching (MPLS) network, that may be used in accordance with an embodiment of the invention.

FIG. 2 illustrates an exemplary router that may be used in accordance with an example embodiment of the invention.

FIG. 3 illustrates a more detailed diagram of an exemplary Ethernet line card that may be used in accordance with an example embodiment of the invention.

FIG. 4 illustrates an exemplary single-bucket policing process that may be used in accordance with an example embodiment of the invention.

FIG. 5 illustrates an exemplary double-bucket policing process that may be used in accordance with an example embodiment of the invention.

FIG. 6 illustrates an exemplary process for emulating traffic shaping by using a traffic policing module, in accordance with an example embodiment of the invention.

FIG. 7 illustrates an exemplary depiction of various fields of a meterstate, in accordance with an example embodiment of the invention.

FIGS. 8A and 8B illustrate exemplary values of a translation template for particular service classes, in accordance with an example embodiment of the invention.

FIG. 9 is a logical diagram of a circuit device, in accordance with an example embodiment of the invention.

### DETAILED DESCRIPTION

A description of example embodiments of the invention follows. In the following description, for purposes of explanation, specific nomenclature is set forth to provide a thorough understanding of the example embodiments of the present invention. It will be apparent to one skilled in the art that specific details in the description may not be required to practice the embodiments of the present invention.

Example aspects described herein relate to traffic management (e.g., QoS), and, in particular, to systems, methods, and computer program products for emulating traffic shaping on an Ethernet line card (ELC).

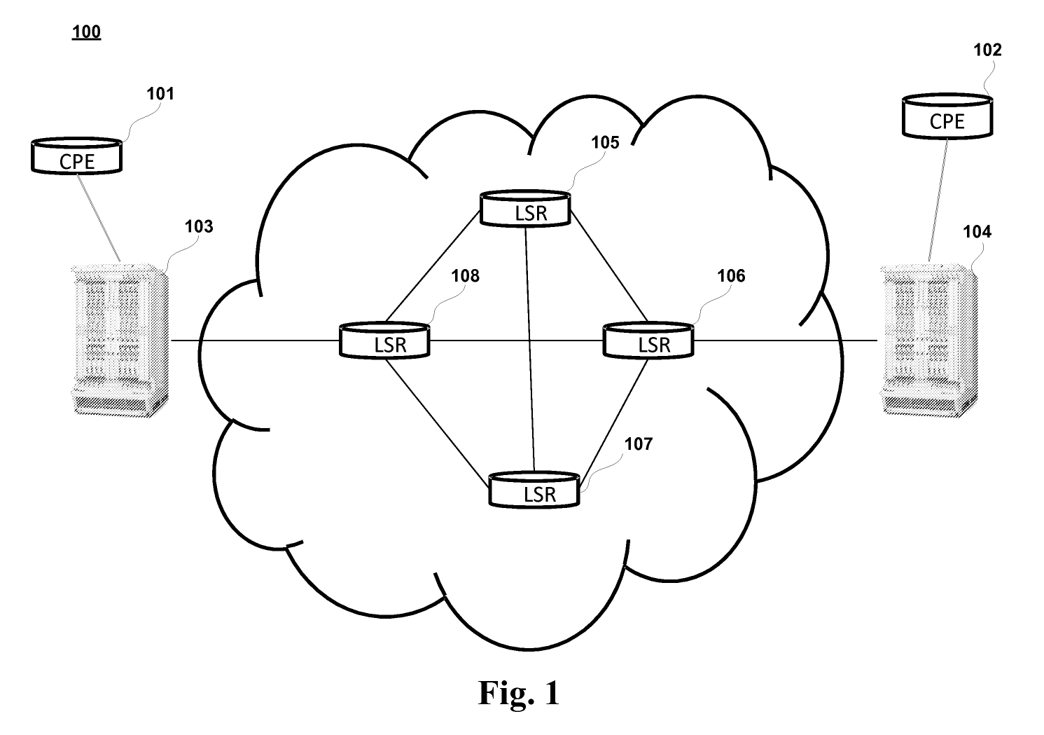

FIG. 1 illustrates an exemplary communication network 100, such as, for example, a multiprotocol label switching (MPLS) network. Network 100 includes customer premises equipment (CPE) 101 and 102. In general, CPE, such as CPE 101 and CPE 102, is any terminal and/or equipment located at a subscriber's premises and which can communicate with a carrier's telecommunication channel. Examples of CPE include a telephone, a router, a switch, a residential gateway, a set-top box, and/or the like.

Network 100 also includes one or more label switch routers (LSRs) 105, 106, 107, and 108. In general, a LSR, such as LSR 104, 105, 106, and 107, is a type of router located within an MPLS network that performs switching of packet labels included in packet headers to route packets throughout the network.

CPE 101 is communicatively connected to LSR 108 via edge router 103. Similarly, CPE 102 is communicatively connected to LSR 106 via edge router 104. An edge router, such as edge router 103 and 104, may also be referred to herein as a “router.” In general, a router forwards data packets between computer networks, computing devices, servers, and the like. In the example shown in FIG. 1, routers 103 and 104 forward data packets between CPE 101, CPE 102, LSR 105, LSR 106, LSR 107, and/or LSR 108.

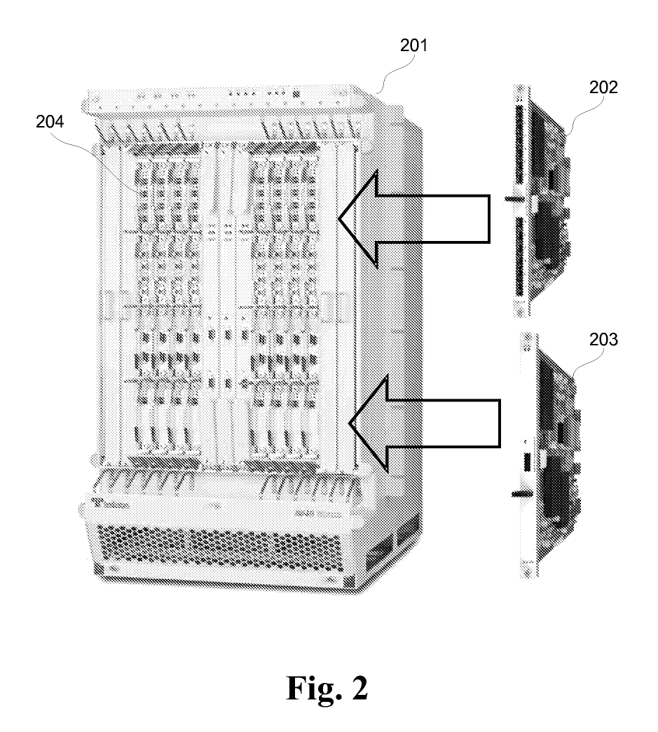

Having described an exemplary communication network, an exemplary router, such as router 103 and/or router 104, that may be included in such a communication network will now be described. FIG. 2 illustrates an exemplary router 201 that may be used in accordance with an example embodiment of the invention. As shown in FIG. 2, router 201 may include one or more Ethernet line cards (ELCs) 204, such as ELC 202 and/or ELC 203, which, in general, are network interface controllers that enable network devices to communicate in accordance with an Ethernet communication protocol. Exemplary ELCs 204 that may be used in accordance with example embodiments of the invention are described in, for example, the publication by Tellabs®, entitled “Tellabs® 8800 Series 12×1 Gigabit Ethernet Line Card (ELC)”, Rev. B, pages 1 to 2, Tellabs®, August 2010, (hereinafter “Tellabs® 12×1 ELC”), and/or the publication by Tellabs®, entitled “Tellabs® 8800 Series 1-Port 10 Gigabit Ethernet Line Card (ELC)”, Rev. B, pages 1 to 2, Tellabs®, August 2010, (hereinafter “Tellabs® 1-Port 10 ELC”), although the ELCs 204 are not limited to these examples only. The Tellabs® 12×1 ELC publication and the Tellabs® 1-Port 10 ELC publication are hereby incorporated by reference in their entireties, as if set forth fully herein.

In the example of FIG. 2, ELC 202 is shown that includes twelve gigabit Ethernet ports. Also shown in FIG. 2 is ELC 203 that includes, in this example, one ten-gigabit Ethernet port. Of course, the number of ELCs represented in the Figures, and the number of Ethernet ports referred to herein (below and above) are for purposes of illustration only, and the invention should not be construed as being limited only thereto.

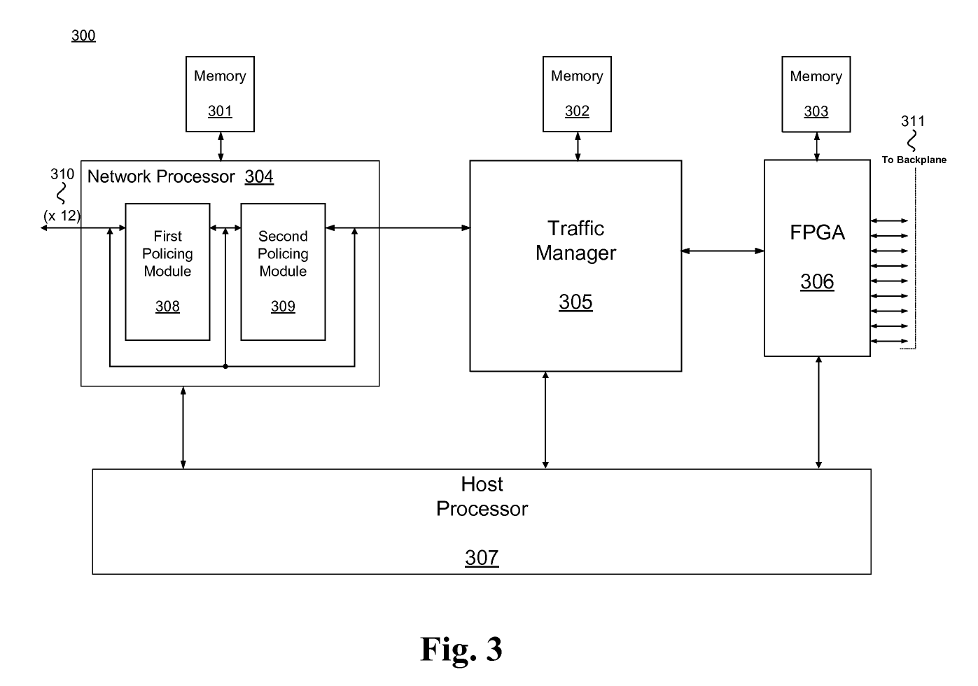

An example of a ELC which is usable in such a router will now be described, with reference to the block diagram of FIG. 3. ELC 300 shown in FIG. 3 includes twelve gigabit Ethernet ports 310, which may be, for example, Serial Gigabit Media Independent Interface (SGMII) bidirectional optical inputs/outputs. Alternatively, an ELC that includes one ten-gigabit Ethernet port may be employed and can be similar to the ELC shown in FIG. 3, except that the twelve Ethernet ports 310 may be replaced with one XAUI ten-gigabit bidirectional optical input/output (not shown).

ELC 300 includes a network processor 304 that performs various network processing functions, such as packet classification, editing, metering, multicasting, and/or media access control (MAC) functions. Network processor 304 includes a first policing module 308 and a second policing module 309 which each implement a traffic policing algorithm, such as, e.g., a token bucket algorithm for traffic policing, described in more detail below. In one example embodiment, and in accordance with an example aspect of the invention, the second policing module 309 is used to emulate traffic shaping by performing shaping of traffic, as discussed in more detail below.

ELC 300 also includes memory unit 301, which is communicatively connected to network processor 304. Memory unit 301 may include tables, counters, meters, and the like that are used by network processor 304 in performing its functions. In some example embodiments, memory unit 301 may include one or more of a classification memory, connection identifier(s) (described in further detail below), packet classification look-up table(s) and/or result(s) (e.g., an SRAM of classification lookup results implemented as x (e.g., three) parallel y-bit (e.g., 64-bit) SRAM interfaces, at least one of which may include automatic protection switching (APS) capability in hardware and/or software), statistics and meter SRAMs, and/or packet forwarding information.

ELC 300 includes a traffic manager 305 that is communicatively connected to network processor 304. Traffic manager 305 performs various traffic management functions, such as, for example, traffic shaping. Although, as discussed in further detail below, in some cases a traffic manager may be used for component 305 that lacks shaping capabilities sufficient to support a wide range of service classes. Traffic manager 305 also is communicatively connected to a memory unit 302. In one example embodiment, memory unit 302 includes a four-gigabit primary data buffer structured with two gigabits used for ingress and two gigabits used for egress (although those numbers of gigabits are not intended to limit the scope of the invention, and others can be employed). In another example embodiment, memory unit 302 also includes a statistics SRAM and/or a pointer SRAM. In further example embodiments, stored in memory unit 302 are packet classification results, connection identifier(s) (described in further detail below), packet classification look-up table(s) and/or result(s), and/or packet forwarding information.

Traffic manager 305 also is communicatively connected to a field programmable gate array (FPGA) 306, which serves as an interface between other ELC components (e.g., network processor 304, traffic manager 305, and/or host processor 307) and a switch fabric (not shown) via a backplane 311.

ELC 300 also includes a host processor 307, which is communicatively connected to network processor 304, traffic manager 305, and FPGA 306. Host processor 307 can be used to perform various processing functions required by ELC 300. In some example embodiments, host processor 307 performs network control signaling functions in accordance with, for example, the open shortest path first (OSPF) protocol, the label distribution protocol (LDP), the resource reservation protocol (RSVP), and/or in accordance with any other suitable protocols. In further example embodiments, host processor 307 executes software instructions to program the first policing module 308 and/or the second policing module 309.

Although not shown in FIG. 3, in one example embodiment, ELC 300 also can include power generation and clock generation modules, as well as other optical components, such as, for example, optical fiber management components.

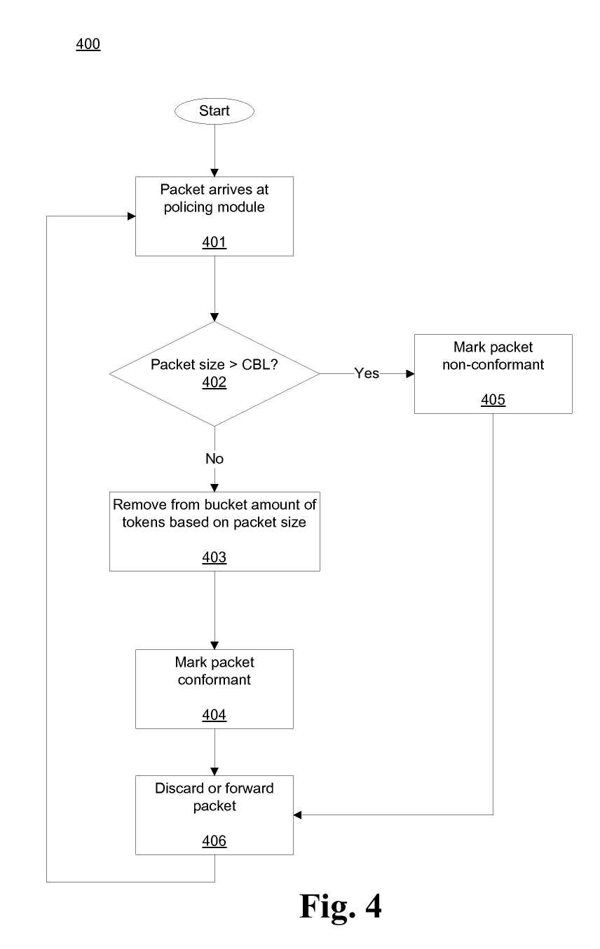

As shown in FIG. 3, in one example embodiment, memory units 301, 302, and 303 are communicatively connected to network processor 304, traffic manager 305, and FPGA 306, respectively. It should be understood that although these memory units are shown separately, in other example embodiments, they may be combined or separated into any number of memory units. Alternatively, or in addition, the memory units may be incorporated into one or more other components of ELC 300, such as, for example, network processor 304, traffic manager 305, FPGA 306, and/or host processor 307. In addition, in one example embodiment, software, such as computer instructions, for performing any procedure described herein may be stored in one or more of memory units 301, 302, and 303, and may be retrieved and executed by those ones of network processor 304, traffic manager 305, FPGA 306, host processor 307, first policing module 308, and/or second policing module 309, which perform applicable parts of the procedures. In one example, software having instructions for performing the procedures of FIGS. 4, 5, and 6 is stored in memory 301 and can be retrieved for execution by the network processor 304.

Having described an exemplary ELC, an exemplary policing process 400 that may be implemented by such an ELC will now be described. As described above with respect to FIG. 3, ELC 300 includes the first policing module 308 and the second policing module 309 that each implement a traffic policing algorithm, such as, e.g., a token bucket algorithm for traffic policing. In one example embodiment, each policing module 308 and 309 can implement, for example, a single-bucket policing process or a double-bucket policing process, although those examples are non-limiting.

FIG. 4 illustrates an exemplary single-bucket policing process 400 that can be implemented by the first policing module 308 and/or the second policing module 309 in accordance with an example embodiment of the invention. For the sake of simplicity, the following description of a single-bucket policing process 400 will be described with respect to the first policing module 308 performing process 400. But this example should not be construed as limiting. That is, the following description may also apply with respect to the second policing module 309 performing process 400.

Process 400 is based on an analogy of a bucket that contains tokens, each of which may represent a unit of bytes or a single packet of predetermined size. The bucket(s) described herein can be implemented in various different ways, such as, for example, as a buffer of a particular size, a controllable upward/downward counter, and/or the like. In particular, in parallel with the single-bucket policing process 400, a token is periodically added by the first policing module 308 to a committed bucket at a predetermined rate referred to as a committed information rate (CIR) (e.g., x tokens per second, x bits per second, etc.). A CIR is a data rate at which a service provider agrees to be able to communicate packets of a particular service class, across a network to one or more other network components (e.g., CPE 101, CPE 102, LSR 105, LSR 106, LSR 107, and/or LSR 108). The maximum number of tokens that the committed bucket can contain is referred to as the committed bucket size (CBS). No tokens are added to the committed bucket while the committed bucket contains a number of tokens equal to its committed bucket size. The number of tokens contained in the committed bucket at any given time is referred to as the committed bucket level (CBL). CIR, CBS, and/or CBL can be stored in, and/or retrieved from, a memory such as memory unit 301, by network processor 304, first policing module 308, and/or second policing module 309.

At block 401, a packet arrives at first policing module 308, from one or more other network components (e.g., CPE 101, CPE 102, LSR 105, LSR 106, LSR 107, and/or LSR 108). At block 402, a determination is made as to whether a size of the packet exceeds the CBL. If the size of the packet does not exceed the CBL (“no” at block 402), then, at block 403, a number of tokens (e.g., a number of bits or bytes) corresponding to the size of the packet are removed from the committed bucket (e.g., a buffer of x bits or bytes). At block 404, the packet is marked as conformant. At block 406, the packet is discarded or forwarded by the first policing module 308 to further network components (e.g., the second policing module 309, the traffic manager 305, etc.), in accordance with a predetermined network administrative policy. Control then passes back to block 401 to process a next packet that arrives at the first policing module 308 based on the process 400.

If the size of the packet exceeds the CBL (“yes” at block 402), then no tokens are removed from the committed bucket and, at block 405, the packet is marked as non-conformant. At block 406, the packet is discarded or forwarded by the first policing module 308 to further network components (e.g., the second policing module 309, the traffic manager 305, etc.), in accordance with a predetermined network administrative policy. Control then passes to block 401 to process a next packet that arrives at the first policing module 308.

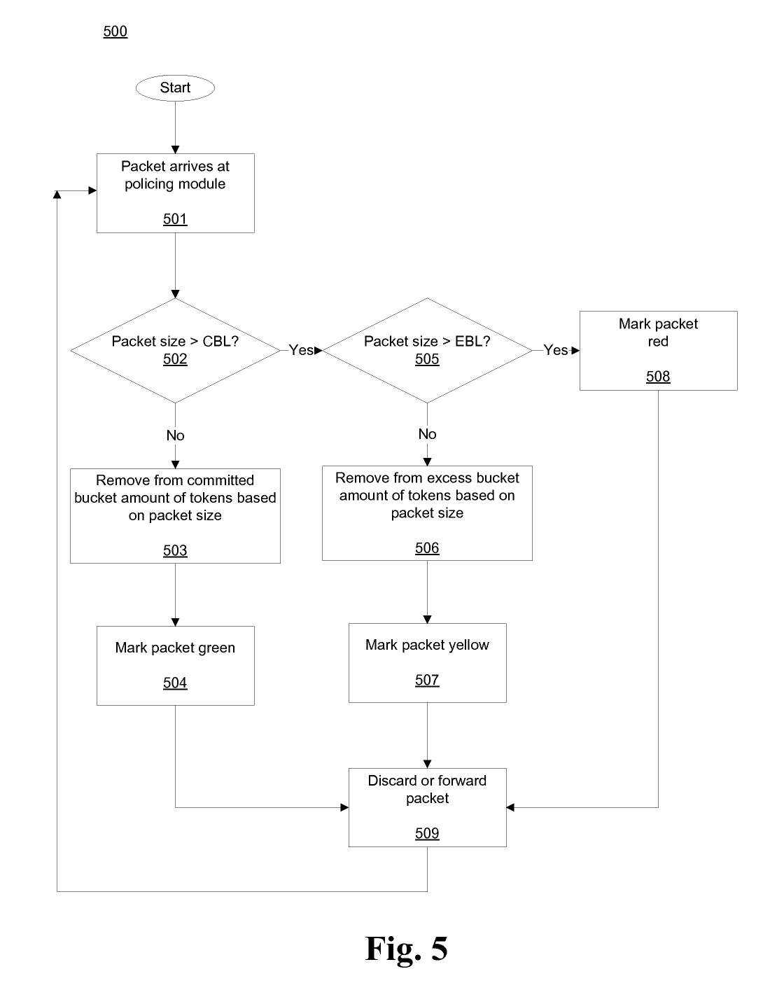

Having described an exemplary single-bucket policing process 400, an exemplary double-bucket policing process 500 that may be implemented by an ELC will now be described with reference to FIG. 5. For the sake of simplicity, the following description of a double-bucket policing process 500 will be described with respect to the first policing module 308 performing the process 500. But this example should not be construed as limiting. That is, the following description may also apply with respect to the second policing module 309 performing the process 500.

Process 500 is based on an analogy of buckets that each contain tokens that may represent a unit of bytes or a single packet of predetermined size. In addition to including a committed bucket, a double-bucket version of the token bucket algorithm includes an excess bucket. In parallel with the double-bucket policing process 500, tokens (e.g., a number of bits or bytes) are periodically added by first policing module 308 to the committed bucket (e.g., a buffer of x bits or bytes) and the excess bucket (e.g., a buffer of x bits or bytes) at a predetermined CIR (e.g., x tokens per second, x bits per second, etc.) and a predetermined excess information rate (EIR) (e.g., x tokens per second, x bits per second, etc.), respectively. The maximum number of tokens that the excess bucket can contain is referred to as an excess bucket size (EBS). No tokens are added to the excess bucket while the excess bucket contains a number of tokens equal to its excess bucket size. The number of tokens contained in the excess bucket at any given time is referred to as the excess bucket level (EBL). EIR, EBS, and/or EBL can be stored in, and/or retrieved from, a memory such as memory unit 301, by network processor 304, first policing module 308, and/or second policing module 309.

At block 501, a packet of a particular size arrives at the first policing module 308, from one or more other network components (e.g., CPE 101, CPE 102, LSR 105, LSR 106, LSR 107, and/or LSR 108). At block 502, a determination is made as to whether the size of the packet exceeds the CBL. If the size of the packet does not exceed the CBL (“no” at block 502), then, at block 503, a number of tokens corresponding to the size of the packet are removed from the committed bucket. Some policing modules use colors (e.g., green, yellow, red) to indicate levels of conformance. At block 504, for instance, the packet is marked as green to indicate, e.g., a relatively high level of conformance. At block 509, the packet is discarded or forwarded by the first policing module 308 to further network components (e.g., the second policing module 309, the traffic manager 305, etc.), in accordance with a predetermined network administrative policy. Control then passes back to block 501 to process a next packet that arrives at the first policing module 308.

If the size of the packet exceeds the CBL (“yes” at block 502), then a determination is made at block 505 as to whether the size of the packet exceeds the EBL. If the size of the packet exceeds the CBL, but not the EBL (“yes” at block 502 and “no” at block 505), then, at block 506, a number of tokens corresponding to the size of the packet is removed from the excess bucket. At block 507, the packet is marked as yellow to indicate, e.g., an intermediate level of conformance. At block 509, the packet is discarded or forwarded by the first policing module 308 to further network components (e.g., the second policing module 309, the traffic manager 305, etc.), in accordance with a predetermined network administrative policy. Control then passes back to block 501 to process a next packet that arrives at the first policing module 308.

If the size of the packet exceeds the CBL and the EBL (“yes” at blocks 502 and 505), then no tokens are removed from either the committed bucket or the excess bucket, and, at block 508, the packet is marked as red to indicate, e.g., a level of non-conformance. After a packet has been marked red, the packet may be discarded or forwarded (block 509) by the first policing module 308 to further network components (e.g., the second policing module 309, the traffic manager 305, etc.), in accordance with a predetermined network administrative policy. Control then passes back to block 501 to process a next packet that arrives at the first policing module 308.

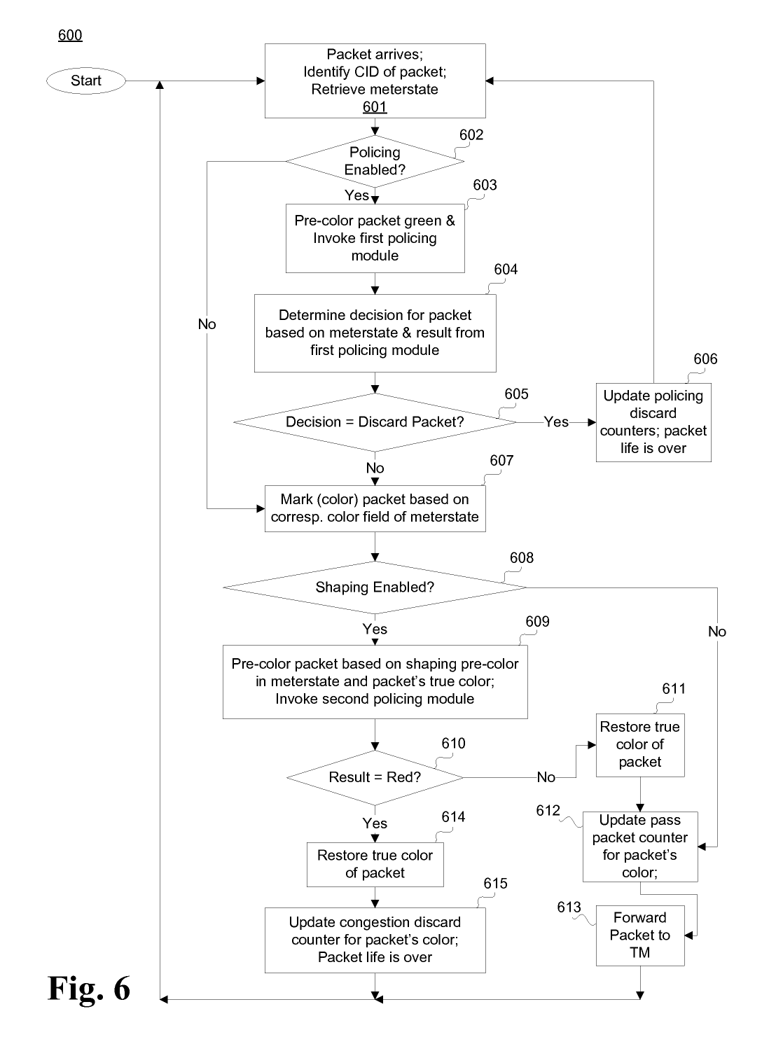

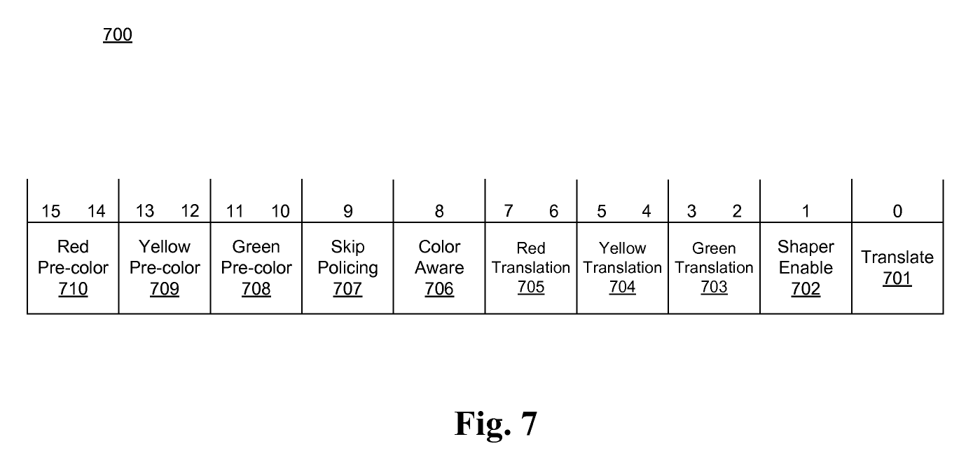

Having described exemplary traffic policing processes, an exemplary process for emulating traffic shaping by utilizing such policing processes will now be described, according to an example aspect of the invention. FIG. 6 illustrates an exemplary process 600 for emulating traffic shaping by using a traffic policing module, in accordance with an example embodiment of the invention. At block 601, after a packet has arrived at network processor 304 from one or more other network components (e.g., CPE 101, CPE 102, LSR 105, LSR 106, LSR 107, and/or LSR 108), a connection identifier (CID) of the packet is retrieved from a header of the packet. The CID is a unique code, such as, for example, a 16-bit binary code, that uniquely identifies a predetermined type of network traffic for the packet. Stored in memory 301 is a table (not shown) that links each possible CID (e.g., a 16-bit value) to a particular meterstate, which is a 16-bit value including the fields such as those indicated in FIG. 7. The network processor 304 then retrieves, from memory 301, the meterstate that corresponds to the CID of the packet (block 601).

Before further aspects of the process 600 of FIG. 6 are described, an exemplary meterstate that may be utilized by process 600 will now be described. One example of various fields of a meterstate 700, in accordance with an example embodiment, is represented in FIG. 7. As shown in FIG. 7, the meterstate includes several fields that indicate how a particular packet should be handled. In particular, a translate field 701 defined by bit 0 is used to indicate whether a color translation is enabled for a packet. In some example embodiments, this bit need not be used. A shaper enable field 702 defined by bit 1 is used to indicate whether shaping is enabled for the packet.

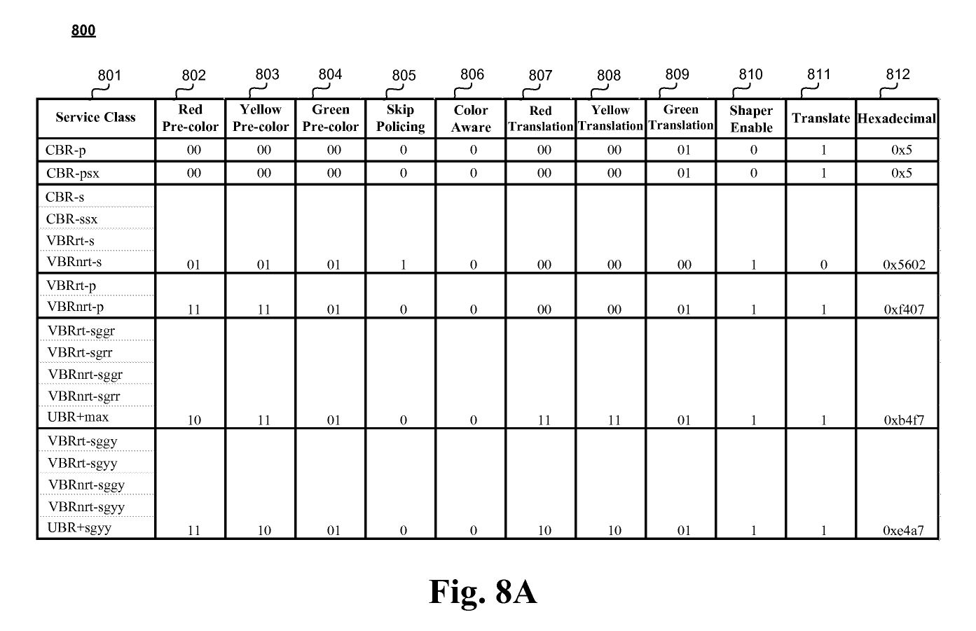

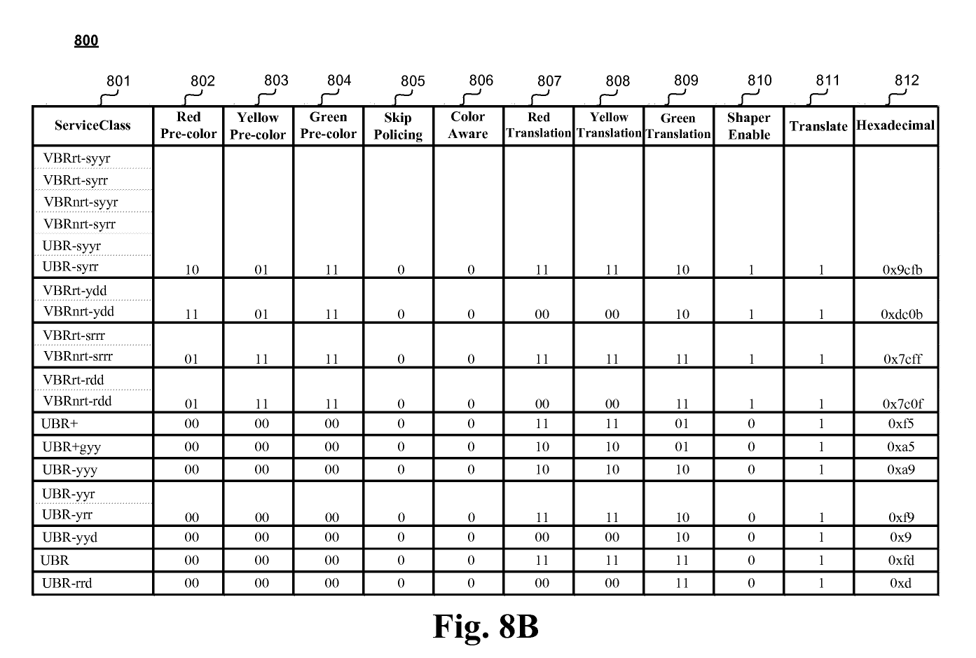

In one example embodiment, the first policing module 308 is color-aware, only a first bucket is used, and green is the pre-color used (in block 603 described below) for all service classes. Some service classes, however, define the conformant color as red (or yellow) and the non-conformant color as yellow (or discard). For example, for the service class CBR-p (FIG. 8A), the return value of yellow or red is translated to “discard.” A color translation (meterstate 700), therefore, is used to label packets with the appropriate colors based on their service classes. This may provide compatibility with a wide range of service classes.

In FIG. 7, a green translation field 703 defined by bits 2 and 3 is used to indicate a color translation result for a packet that previously has been marked green. A yellow translation field 704 defined by bits 4 and 5 is used to indicate a color translation result for a packet that previously has been marked yellow. A red translation field 705 defined by bits 6 and 7 is used to indicate a color translation result for a packet that previously has been marked red. A color aware field 706 defined by bit 8 is reserved for future use.

A skip policing field 707 defined by bit 9 is used to indicate whether policing is to be skipped for the packet. A green pre-color field 708 defined by bits 10 and 11 is used to indicate a pre-color result to be used prior to shaping a packet that previously has been marked green. A yellow pre-color field 709 defined by bits 12 and 13 is used to indicate a pre-color result to be used prior to shaping a packet that previously has been marked yellow. A red pre-color field 710 defined by bits 14 and 15 is used to indicate a pre-color result to be used prior to shaping a packet that previously has been marked red.

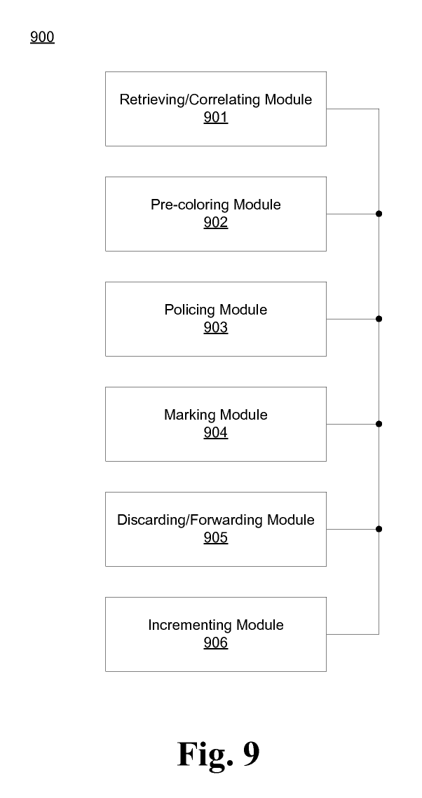

Having described an exemplary meterstate 700, an exemplary translation template 800, which may include several meterstates, that may be utilized by process 600 will now be described. FIGS. 8A and 8B illustrate exemplary values of a translation template 800 for particular service classes, in accordance with an example embodiment of the invention. In particular, the translation template 800 includes meterstates for service classes. As discussed above with respect to FIG. 7, each meterstate (i.e., each row of FIGS. 8A or 8B) includes several fields that indicate how a packet associated with that meterstate should be handled by network processor 304. In the example of FIGS. 8 and 9, the translation template 800 includes a column corresponding to service classes (column 801). Service classes in the service classes column 801 are indicated by codes including, for example, CBR (indicating a constant bit rate), VBR (indicating a variable bit rate), UBR (indicating an unspecified bit rate), s (indicating that shaping is enabled), p (indicating that policing is enabled), rt (indicating realtime), nrt (indicating non-realtime), etc., although this example should not be construed as limiting. Service classes may be instead be indicated by, for example, binary codes, or any other suitable means.

The translation template 800 also includes columns that respectively correspond to the fields described above with respect to FIG. 7. In particular, the translation template 800 includes columns that respectively correspond to a red pre-color field 710 (column 802), a yellow pre-color field 709 (column 803), a green pre-color field 708 (column 804), a skip policing field 707 (column 805), a color aware field 706 (column 806), a red translation field 705 (column 807), a yellow translation field 704 (column 808), a green translation field 703 (column 809), a shaper enable field 702 (column 810), and a translate field 701 (column 811). For each meterstate (i.e., each row of FIGS. 8A or 8B), the corresponding values of the fields under columns 802 through 811 indicate how a particular packet should be handled (e.g., whether a packet should be policed and/or shaped), as described above with respect to FIG. 7.

The entries of a hexadecimal column 812 illustrate shorthand representations of the meterstates (i.e., the 16 bits that make up columns 802 through 811) for particular service classes 801. In some example embodiments, translation template 800 need not include column 812.

Although not explicitly shown in FIGS. 7, 8A, or 8B, for each service class there is an associated predetermined CIR to be used for the committed bucket of the first policing module 308 as well as an associated predetermined CIR to be used for the committed bucket of the second policing module 309. In addition, if either the first or second policing module 308 or 309 is configured as a double-bucket policing module (e.g., by including two buffers of sizes x and y, or counters corresponding to the committed bucket and the excess bucket, respectively), then for each service class there is also an associated predetermined EIR to be used for the excess bucket of that policing module. By tailoring the CIR and/or EIR on a service class basis, policing and/or shaping may be tailored on a per-service class basis.

Having described an exemplary meterstate 700 and an exemplary translation template 800 that may be utilized by process 600, further aspects of the process 600 of FIG. 6 will now be described. In one example embodiment, the process 600 is performed by the network processor 304, and the policing performed as part of blocks 603 and 609 is performed by the first policing module 308 and the second policing module 309, respectively, of the network processor 304. Of course, in other embodiments, the modules 308 and 309 can perform the procedures 609 and 603, respectively.

At block 602, a determination is made as to whether policing is enabled for the packet. This determination is made based on the value of the skip policing field (which is discussed in more detail below) in the meterstate of the packet. If policing is not enabled (i.e., the skip policing field is set) (“no” at block 602), then control passes directly to block 607, to be described below. In one embodiment, for a service class for which policing is not enabled, such as CBR-s (FIG. 8A), the CIR of the first policing module 308 may be set at, for example, 10 gigabits per second (or some other bit rate) to simplify the counting of packets discarded due to policing decisions, to be described below with respect to block 606.

If policing is enabled (i.e., the skip policing field is not set) (“yes” at block 602), then, control passes to block 603. At block 603, the packet is pre-colored (i.e., marked with a color prior to the invoking of the first policing module 308) green and the first policing module 308 is invoked for the packet.

Upon being invoked at block 603, the first police module 308 performs a policing process (such as, for example, one of the token bucket algorithms for traffic policing described above with respect to processes 400 and/or 500) to determine a policing result (e.g., color or discard) for the packet. Example policing results include a color of green, yellow, or red, or an indication that the packet should be discarded.

At block 604, a translation decision for the packet is determined by retrieving, from the meterstate for the packet, a value of a translation field corresponding to the policing result obtained at block 603. For example, if the policing result of the packet at block 603 is green, then, at block 604, the packet is marked with, or translated to, the value (e.g., color or discard) indicated by the green translation field 703 of the meterstate of the packet. If the policing result of the packet at block 603 is yellow, then the packet's color is translated to the value (e.g., color or discard) indicated by the yellow translation field 704 of the meterstate of the packet. If the policing result of the packet at block 603 is red, then the packet's color is translated to the value (e.g., color or discard) indicated by the red translation field 705 of the meterstate of the packet. In an example embodiment, the possible values of the two-bit fields in these translations include a value of 00 (which corresponds to discard), a value of 01 (which corresponds to green), a value of 10 (which corresponds to yellow), a value of 11 (which corresponds to red).

At block 605, a determination is made as to whether the determination at block 604 indicates that the packet is to be discarded (i.e., that the translation decision is discard). If it is determined at block 605 that the packet is to be discarded (“yes” at block 605), then, at block 606, the packet is discarded. Packets discarded based on a determination of the first policing module 308 (i.e., packets discarded at block 606) may be counted as policing discards by incrementing a policing discard counter at block 606. The policing discard counter may be used to store network traffic statistics, such as, for example, a number of packets discarded by the first policing module 308. The network traffic statistics stored by the policing discard counter may be utilized in online and/or offline network administration. For example, information technology (IT) personnel can adjust network settings based on the statistics stored in the policing discard counter to improve network QoS. Control then passes to block 601 to process the next packet to arrive at the network processor 304.

If it is determined that the packet is not to be discarded (“no” at block 605), then control passes to block 607, which will now be described. At block 607, the packet being processed is marked (or colored) based on the translation template 800, in a similar manner as discussed above in connection with block 604. The result of the marking of the packet performed at block 607 may be referred to herein as the final, or true, color for the particular packet.

At block 608, a determination is made as to whether the shaper enable bit 702 is set in the meterstate for the packet. In particular, the determination is made by retrieving a value of the shaper enable bit 702 field from the meterstate for the packet.

If a determination is made, at block 608, that the shaper enable bit 702 is not set in the meterstate for the packet (“no” at block 608), then control passes to block 612. For service classes with shaping not enabled, such as CBR-p (FIG. 8A), the second policing module 309 is not invoked and the CIR (and/or EIR) of the second policing module 309 does not affect the packet. At block 612, a pass packet counter is incremented for that packet's color. The pass packet counter may be used to store network traffic statistics, such as, for example, a number of packets successfully forwarded by policing module 308. The network traffic statistics stored by the pass packet counter may be utilized in online and/or offline network administration. For example, information technology (IT) personnel can adjust network settings based on the statistics stored in the pass packet counter to improve network QoS. At block 613, the packet is forwarded to the traffic manager 305. Control then passes to block 601 to process the next packet to arrive at the network processor 304.

If a determination is made at block 608 that the shaper enable bit 702 is set in the meterstate for the packet (“yes” at block 608), then, at block 609, the packet is pre-colored (i.e., marked with a color prior to the invoking of the second policing module 309) based on the true color of the packet (i.e., the color the packet was marked with at block 607) and a corresponding pre-color field (i.e., the green pre-color field 708, the yellow pre-color field 709, or the red pre-color field 710) in the meterstate for the packet. For example, if the true color of the packet is green, then a value of the green pre-color field 708 in the meterstate of the packet is retrieved and the packet is pre-colored, or marked, based on the retrieved value. If the true color of the packet is yellow, then a value of the yellow pre-color field 709 in the packet's meterstate is retrieved and the packet is pre-colored, or marked, based on the retrieved value. If the true color of the packet is red, then a value of the red pre-color field 710 in the packet's meterstate is retrieved and the packet is pre-colored, or marked, based on the retrieved value.

In one example embodiment, a code corresponding to the color red (e.g., a binary value of “11”) is included within a pre-color field (translation template 800) that corresponds to a color that is not part of a particular service class. For example, if a service class does not include the color yellow, the yellow pre-color field 712 for that service class is populated with, e.g., “11” corresponding to red. In the event that the first policing module 308 erroneously marks a packet with a resulting color that is not part of a service class (e.g., yellow), then by pre-coloring packets of that color as red prior to invoking the second policing module 309, the packet may be deemed non-conformant by the second policing module 309 and may thus be discarded.

Referring again to FIG. 6, after the packet has been pre-colored as described above regarding block 609, the second policing module 309 is invoked at block 609 for the packet. As described in more detail below, upon being invoked, the second police module 309 performs a policing process (such as, for example, the token bucket algorithm for traffic policing described above) to determine a policing result for the packet. Example policing results include a color of green, yellow, or red, or an indication that the packet should be discarded.

Before further describing that process 600, an example of the utilization of second policing module 309 to emulate shaping will now be described. As described above, in some cases, traffic manager 305 may not support sufficient shaping for ingress traffic. Shaping, therefore, is emulated through the use of the second policing module 309. Although the second policing module 309 may lack a queue to be used in delaying packets—as may be done by a traditional shaping module—the second policing module 309 may nonetheless, through the techniques described herein, be used to emulate such shaping.

In the second policing module 309, a two-bucket policing operation (distinct from the policing operation of the first policing module 308) is invoked for a packet. The second policing module 309 may be configured to police as a single-rate or double-rate policer. To configure the second policing module 309 as single-rate, the rate of the second bucket of the second policing module 309 is pre-set to be less than the rate of the first bucket of the second policing module 309. For example, in one example service class, which requires that traffic be shaped at a minimum rate of the service class, the rate of the first bucket of the second policing module 309 may be set equal to the minimum rate of the service class and the rate of the second bucket of the second policing module 309 may be set to zero. This results in traffic of this service class effectively being shaped at a single rate, namely, the rate of the first bucket of the second policing module 309 (which, in this example, is equal to the minimum rate).

The second policing module 309 can be configured as double-rate, for instance, for service classes that require traffic to be shaped at a maximum rate. For example, in one example service class, which requires that higher priority traffic be shaped at a maximum rate of the service class, the rate of the first bucket of the second policing module 309 may be set to be equal to the minimum rate of the service class, and the rate of the second bucket of the second policing module 309 may be set to be equal to the maximum rate of the service class minus the minimum rate of the service class. Packets of the service class are pre-colored (block 609) with either a higher priority color (e.g., green) or a lower priority color (e.g., yellow), based on the meterstate (retrieved at block 601) corresponding to each packet. The higher priority colored (e.g., green) packets are checked for conformance against both the first bucket and the second bucket, which results in those packets effectively being shaped at a rate equal to the sum of the rate of the first bucket and the rate of the second bucket (in this example, the sum of the rate of the first bucket and the rate of the second bucket equals the maximum rate). The lower priority colored (e.g., yellow) packets are checked for conformance against only the second bucket, which results in those packets being shaped at the rate of the second bucket (in this example, the rate of the second bucket equals the maximum rate minus the minimum rate) plus any surplus from the first bucket.

In one example embodiment, the CBS and EBS of the second policing module 309 are set to emulate congestion thresholds that would be set on a universal line card (ULC) for a similar service class. The EBS is set to correspond to the number of bytes in a ULC buffer for a lower color of the service class. The CBS is set to correspond to a total buffer size minus the EBS. Such a breakup may be used to emulate a congestion discard algorithm, sometimes also referred to as tail drop without hysteresis.

In another example embodiment, a higher-colored packet of a service class is pre-colored as green at block 609. The packet is checked for conformance against the committed bucket. If the packet is deemed to be non-conformant (i.e., the packet does not conform to the limits of the committed bucket), then the packet is checked at block 609 for conformance against the excess bucket. This is analogous to making the entire buffer available to the higher-colored packet.

In yet another example embodiment, a lower-colored packet of a service class is pre-colored as yellow at block 609. The packet is checked for conformance at block 609 only against the excess bucket. This is analogous to making only a portion of the entire buffer available to the lower-colored packet.

Having described the utilization of second policing module 309 to emulate shaping, block 610 of FIG. 6 will now be described. At block 610, a determination is made as to whether a result from the invoking of the second policing module 309 is red. If it is determined that a result of the shaping is not red (“no” at block 610) (e.g., a result of the shaping is green or yellow), this indicates a lack of congestion and that the packet should be forwarded. Thus, at block 611 the packet is restored to its true color (i.e., the color discussed above in connection with block 607). Then, at block 612 a pass packet counter is incremented for the packet's color. At block 613, the packet is then forwarded to the traffic manager 305. Control then passes to block 601 to process the next packet to arrive at the network processor 304.

If it is determined at block 610 that a result of the shaping is red (“yes” at block 610), this indicates that the packet should be discarded owing to congestion. Thus, at block 614 the packet is restored to its true color (i.e., the color discussed above in connection with block 607). Irrespective of the color returned by the second policing module 309 for a packet, the final color of the packet is still the color marked with its true color. That is, the packet is marked based on the color translation field of the meterstate of the packet that corresponds to the value returned by the first policing module 308 (i.e., the color discussed above in connection with block 607).

At block 615, the packet is discarded. Packets discarded owing to the second policing module 309 (i.e., packets discarded at block 615) may be counted as shaping, or congestion, discards by incrementing a congestion discard counter at block 615 for that packet's color. The congestion discard counter may be used to store network traffic statistics, such as, for example, an amount of packets discarded by the second policing module 309. The network traffic statistics stored by the congestion discard counter may be utilized in online and/or offline network administration. For example, information technology (IT) personnel can adjust network settings based on the statistics stored in the congestion discard counter to improve network QoS. Control then passes to block 601 to process the next packet to arrive at the network processor 304.

As can be appreciated in view of the foregoing description, even in cases in which an ELC is employed that may not provide queues and/or shaping modules sufficient to support per-service queuing and/or shaping of ingress traffic, by virtue of configuring the ELC to emulate per-service shaping using policing modules of the ELC, the ELC may nonetheless be able to support service classes that require such traffic shaping, in accordance with an example aspect of the invention.

In the foregoing description, example aspects of the invention are described with reference to specific example embodiments. The specification and drawings are accordingly to be regarded in an illustrative rather than in a restrictive sense. It will, however, be evident that various modifications and changes may be made thereto, in a computer program product or software, hardware, firmware, or any combination thereof, without departing from the broader spirit and scope of the present invention.

Software embodiments of example aspects described herein may be provided as a computer program product, or software, that may include an article of manufacture on a computer-accessible or computer-readable medium (memory) having instructions. The instructions on the computer-accessible or computer-readable medium may be used to program a computer system or other electronic device. The computer-readable medium may include, but is not limited to, floppy diskettes, optical disks, CDROMs, magneto-optical disks, and semiconductor devices such as FLASH memory, or other types of media/computer-readable medium suitable for storing or transmitting electronic instructions.

The techniques described herein are not limited to any particular software configuration. They may find applicability in any computing or processing environment. The terms “computer-accessible medium”, “computer-readable medium”, or “memory” used herein shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result. In other example embodiments, functions performed by software can instead be performed by hardcoded modules, and thus the invention is not limited only for use with stored software programs. Indeed, the numbered parts of the above-identified procedures represented in the drawings may be representative of operations performed by one or more respective modules, wherein each module may include software, hardware, or a combination thereof.

FIG. 9 illustrates a logical diagram 900 of modules of an example system or similarly organized circuit device(s) (e.g., ASIC, PGA, FPGA, and the like) which could be used to form at least part of ELC 300 (in one example, it forms network processor 304) of FIG. 3, in accordance with example embodiments. The modules may include hardware circuitry, software, and/or combinations thereof. Logical diagram 900 includes a module 901 that can perform the procedures of block 601 of FIG. 6, a module 902 that can perform the procedure of block 602, and the pre-coloring procedure of block 603 and/or 609 of FIG. 6, a module 903 that can perform the policing procedure of block 603 and/or 609 (FIG. 6), and also the procedure of block 608, a module 904 that can perform the procedures of blocks 604, 605, 607, 610, 611, and/or 614 of FIG. 6, a module 905 that can perform the packet discard procedure of blocks 606 and 615, and the forwarding procedure of block 613 of FIG. 6, and a module 906 that can perform the updating of the discard counter procedure of blocks 606 and 615, and the updating of the pass packet counter procedure of block 612 of FIG. 6. In other example embodiments of the invention, the number of modules employed can differ from that depicted in FIG. 9, and one or more individual ones of the modules in FIG. 9 can perform more than one of the procedures referred to above, such that any number and combination of modules can be provided.

In addition, it should be understood that the figures illustrated in the attachments, which highlight the functionality and advantages of the present invention, are presented for example purposes only. The architecture of the example aspect of the present invention is sufficiently flexible and configurable, such that it may be utilized (and navigated) in ways other than that shown in the accompanying figures.

Although example aspects of this invention have been described in certain specific embodiments, many additional modifications and variations would be apparent to those skilled in the art. It is therefore to be understood that this invention may be practiced otherwise than as specifically described. Thus, the present example embodiments, again, should be considered in all respects as illustrative and not restrictive.

What is claimed:

1. A system for emulating traffic shaping, the system comprising:
a network processor configured to pre-color a packet to provide a pre-colored packet, and police the pre-colored packet to provide a policed packet.

2. The system of claim 1, wherein the network processor is configured to pre-color the packet based on (i) a meterstate and (ii) a true color of the packet.

3. The system of claim 1, further comprising:
a memory configured to store a table that associates connection identifiers with meterstates, wherein the network processor is further configured to retrieve, from a header of the packet, a connection identifier associated with the packet, and correlate the connection identifier with a meterstate.

4. The system of claim 1, wherein the network processor is further configured to mark the policed packet with a true color of the packet, to provide a marked packet.

5. The system of claim 4, wherein the network processor is further configured to discard or forward the marked packet, based on the policed packet.

6. The system of claim 5, wherein the network processor is further configured to increment a value of at least one of (i) a pass packet counter upon forwarding of the marked packet and (ii) a congestion discard counter upon discarding of the marked packet.

7. The system of claim 2, wherein the meterstate includes at least one of a translate field, a shaper enable field, at least one translation field, a color aware field, a skip policing field, and at least one pre-color field.

8. The system of claim 7, wherein the at least one translation field includes at least one of a green translation field, a yellow translation field, and a red translation field.

9. The system of claim 7, wherein the at least one pre-color field includes at least one of a green pre-color field, a yellow pre-color field, and a red pre-color field.

10. The system of claim 7, wherein the network processor is further configured to pre-color by selecting a value of the at least one pre-color field, based on a true color of the packet, and marking the packet with the value selected in the selecting.

11. The system of claim 1, wherein the network processor is further configured to pre-color by marking the packet with a value corresponding to a color of green.

12. A method for emulating traffic shaping, comprising:
pre-coloring a packet to provide a pre-colored packet; and
policing the pre-colored packet to provide a policed packet.

13. The method of claim 12, wherein the pre-coloring of the packet is performed based on (i) a meterstate and (ii) a true color of the packet.

14. The method of claim 12, further comprising:
retrieving from a header of the packet a connection identifier associated with the packet; and
correlating the connection identifier with a meterstate.

15. The method of claim 12, further comprising marking the policed packet with a true color of the packet, to provide a marked packet.

16. The method of claim 15, further comprising discarding or forwarding the marked packet, based on the policed packet.

17. The method of claim 16, further comprising incrementing a value of at least one of (i) a pass packet counter upon forwarding of the marked packet and (ii) a congestion discard counter upon discarding of the marked packet.

18. The method of claim 13, wherein the meterstate includes at least one of a translate field, a shaper enable field, at least one translation field, a color aware field, a skip policing field, and at least one pre-color field.

19. The method of claim 18, wherein the at least one translation field includes at least one of a green translation field, a yellow translation field, and a red translation field.

20. The method of claim 18, wherein the at least one pre-color field includes at least one of a green pre-color field, a yellow pre-color field, and a red pre-color field.

21. The method of claim 18, wherein the pre-coloring further includes:
selecting a value of the at least one pre-color field, based on a true color of the packet; and
marking the packet with the value selected in the selecting.

22. The method of claim 12, wherein the pre-coloring further includes marking the packet with a value corresponding to a color of green.

23. A non-transitory computer-readable medium having stored thereon sequences of instructions, the sequences of instructions including instructions, which, when executed by a network processor, cause the network processor to perform:
pre-coloring a packet to provide a pre-colored packet; and
policing the pre-colored packet to provide a policed packet.

24. The computer-readable medium of claim 23, the pre-coloring of the packet being based on (i) a meterstate and (ii) a true color of the packet.
